(19) United States
(12) Patent Application Publication
(10) Pub. No.: US 2017/0074107 A1
(43) Pub. Date: Mar. 16, 2017

(54) BLADE/DISK DOVETAIL BACKCUT FOR BLADE DISK STRESS REDUCTION (9E.04, STAGE 2)

(71) Applicant: GENERAL ELECTRIC COMPANY, SCHENECTADY, NY (US)

(72) Inventors: JASON ADAM NEVILLE, GREENVILLE, SC (US); WILLIAM SCOTT ZEMITIS, SIMPSONVILLE, SC (US); MITCHELL MERRILL, TAYLOR, SC (US); SEAN PATRICK DOUGLASS GUNNING, ANDERSON, SC (US)

(21) Appl. No.: 14/854,064

(22) Filed: Sep. 15, 2015

(51) Int. Cl. F01D 5/30

(52) U.S. Cl. CPC F01D 5/3007; F05D 2220/32; F05D 2240/30

(57) ABSTRACT

The present application thus provides a method for reducing stress on at least one of a turbine disk and a turbine blade. The method may include the steps of (a) determining a starting line for a dovetail backcut relative to a datum line, (b) determining a cut angle for the dovetail backcut, and (c) removing material from at least one of the blade dovetail or the disk dovetail slot according to the starting line and the cut angle to form the dovetail backcut. The datum line may be positioned about 2.866 inches (about 72.796 millimeters) from a forward face of the blade dovetail and wherein step (a) is practiced such that for the pressure side of the dovetail, the starting line of the dovetail backcut is at least about 2.566 inches (about 65.176 millimeters) in a forward direction from the datum line.

### TECHNICAL FIELD

The present application and the resultant patent relate generally to gas turbine engines and more particularly relate to a modified turbine blade dovetail and/or disk dovetail slot designed to divert the load path of a mounted turbine blade around a stress concentrating feature in the disk and/or a stress concentrating feature in the turbine blade itself.

### BACKGROUND OF THE INVENTION

Gas turbine disks may include a number of circumferentially spaced dovetails about the outer periphery of the disk defining dovetail slots therebetween. Each of the dovetail slots may receive a turbine blade axially therein. The turbine blade may have an airfoil portion and a blade dovetail having a shape complementary to the dovetail slots. The turbine blade may be cooled by air entering through a cooling slot in the disk and through grooves or slots formed in the dovetail portions of the blade. Typically, the cooling slots may extend circumferentially there around through the alternating dovetails and dovetail slots.

The interface locations between the blade dovetails and the dovetail slots are potentially life-limiting locations due to overhanging blade loads and stress concentrating geometries. In the past, dovetail backcuts have been used in certain turbine engines to relieve such stresses. These backcuts, however, were minor in nature were not optimized to balance stress reduction on the disk, stress reduction on the turbine blades, and a useful life of the turbine blades.

There is thus a desire for improved turbine blades and/or disks and the interaction therebetween. Such improved turbine blades and/or disks may promote overall stress reduction for an improved turbine blade lifetime and improved system efficiency without negatively impacting the aeromechanical behavior of the turbine blades.

### SUMMARY OF THE INVENTION

The present application and the resultant patent thus provide a method for reducing stress on at least one of a turbine disk and a turbine blade. The method may include the steps of (a) determining a starting line for a dovetail backcut relative to a datum line, (b) determining a cut angle for the dovetail backcut, and (c) removing material from at least one of the blade dovetail or the disk dovetail slot according to the starting line and the cut angle to form the dovetail backcut. The datum line may be positioned about 2.866 inches (about 72.796 millimeters) from a forward face of the blade dovetail and wherein step (a) is practiced such that for the pressure side of the dovetail, the starting line of the dovetail backcut is at least about 2.566 inches (about 65.176 millimeters) in a forward direction from the datum line.

The present application and the resultant patent further provide a turbine blade. The turbine blade may include an airfoil and a blade dovetail, the blade dovetail being shaped corresponding to a dovetail slot in a turbine disk, the blade dovetail having a pressure side and a suction side, wherein the blade dovetail includes a dovetail backcut sized and positioned according to optimized blade geometry. A starting line of the dovetail backcut, which defines a length of the dovetail backcut along a dovetail axis, is determined relative to a datum line positioned about 2.866 inches (about 72.796 millimeters) from a forward face of the blade dovetail along a centerline of the dovetail axis, and wherein for the pressure side of the dovetail, the starting line of the dovetail backcut is at least about 2.566 inches (about 65.176 millimeters) in a forward direction from the datum line.

The present application and the resultant patent further provide a turbine rotor including a number of turbine blades coupled with a rotor disk, each blade including an airfoil and a blade dovetail and the rotor disk including a number of dovetail slots shaped corresponding to the blade dovetail, at least one of the blade dovetail and the dovetail slot includes a dovetail backcut sized and positioned according to blade and disk geometry. A starting line of the dovetail backcut, which defines a length of the dovetail backcut along a dovetail axis, is determined relative to a datum line positioned 2.866 inches (72.796 millimeters) from a forward face of the blade dovetail along a centerline of the dovetail axis, and wherein for the pressure side of the dovetail the starting line of the dovetail backcut is at least 2.566 inches (about 65.176 millimeters) in a forward direction from the datum line.

These and other features and improvements of the present application and the resultant patent will become apparent to one of ordinary skill in the art upon review of the following detailed description when taken in conjunction with the several drawings and the appended claims.

### BRIEF DESCRIPTION OF THE DRAWINGS

FIG. 1 is a schematic diagram of a gas turbine engine showing a compressor, a combustor, a turbine, and a load.

FIG. 2 is a perspective view of a turbine disk segment with an attached turbine blade.

FIG. 3 is a perspective view of the suction side of the turbine blade of FIG. 2.

FIG. 4 is a perspective view of the pressure side of the turbine blade of FIG. 2.

FIG. 5 is a partial perspective view of a turbine blade with a turbine blade dovetail as may be described herein.

FIG. 6 is a partial sectional view of the turbine blade dovetail of FIG. 5.

FIG. 7 is a partial perspective view of an alternative embodiment of a turbine blade dovetail as may be described herein.

### DETAILED DESCRIPTION

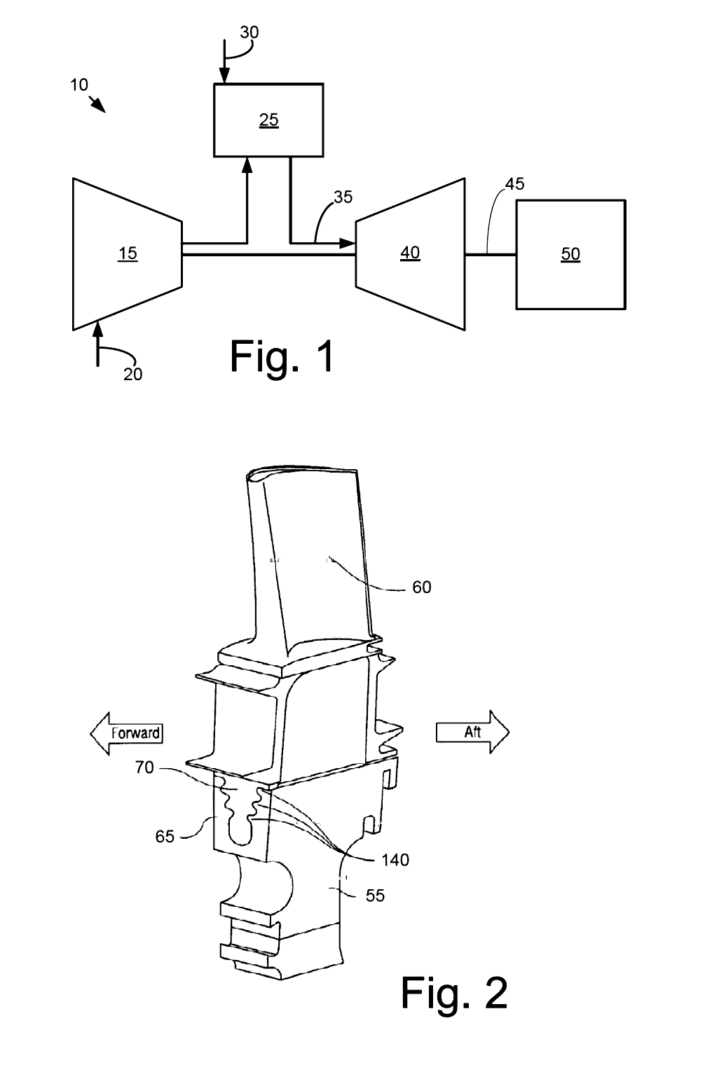

Referring now to the drawings, in which like numerals refer to like elements throughout the several views, FIG. 1 shows a schematic view of gas turbine engine 10 as may be used herein. The gas turbine engine 10 may include a compressor 15. The compressor 15 compresses an incoming flow of air 20. The compressor 15 delivers the compressed flow of air 20 to a combustor 25. The combustor 25 mixes the compressed flow of air 20 with a pressurized flow of fuel 30 and ignites the mixture to create a flow of combustion gases 35. Although only a single combustor 25 is shown, the gas turbine engine 10 may include any number of combustors 25. The flow of combustion gases 35 is in turn delivered to a turbine 40. The flow of combustion gases 35 drives the turbine 40 so as to produce mechanical work. The mechanical work produced in the turbine 40 drives the compressor 15 via a shaft 45 and an external load 50 such as an electrical generator and the like.

The gas turbine engine 10 may use natural gas, various types of syngas, liquid fuels, and/or other types of fuels and blends thereof The gas turbine engine 10 may be any one of a number of different gas turbine engines offered by General Electric Company of Schenectady, N.Y., including, but not limited to, those such as a 7 or a 9 series heavy duty gas turbine engine and the like. The gas turbine engine 10 may have different configurations and may use other types of components. Other types of gas turbine engines also may be used herein. Multiple gas turbine engines, other types of turbines, and other types of power generation equipment also may be used herein together.

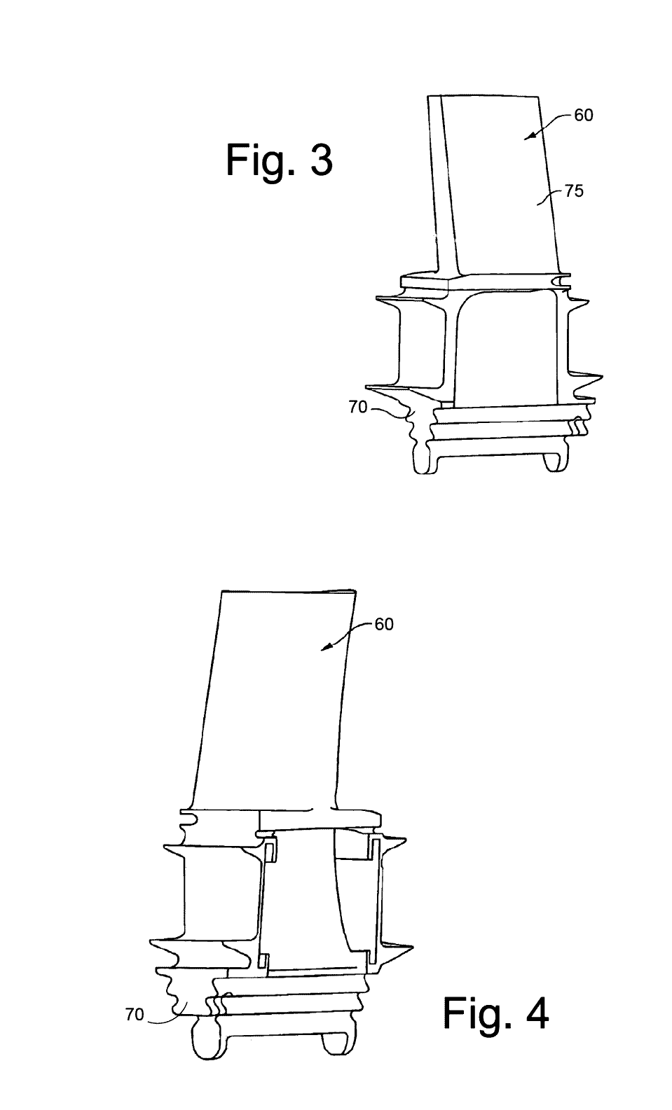

FIG. 2 is a perspective view of an example of a gas turbine disk segment 55 with a gas turbine blade 60. The disk segment 55 may include a dovetail slot 65 that receives a correspondingly shaped blade dovetail 70 to secure the turbine blade 60 to the disk 55. FIG. 3 and FIG. 4 show opposite sides of the turbine blade 60 including an airfoil 75 and the blade dovetail 70. FIG. 3 illustrates a pressure side of the turbine blade 60 and FIG. 4 illustrates a suction side of the turbine blade 12. The dovetail slots 65 typically are termed “axial entry” slots in that the dovetails 70 of the blades 60 may be inserted into the dovetail slots 65 in a generally axial direction, i.e., generally parallel but skewed to the axis of the disk 55.

The interface surfaces between the blade dovetail 70 and the disk dovetail slot 65 may be subject to stress concentrations. An example of a stress concentrating feature may be a cooling slot. As described above, the upstream or downstream face of the turbine blade 60 and the disk 55 may be provided with an annular cooling slot that extends circumferentially there around and passes through a radially inner portion of each dovetail 70 and dovetail slot 65. Cooling air (e.g., compressor discharge air and the like) may be supplied to the cooling slot which in turn supplies cooling air into the radially inner portions of the dovetail slots 65 for transmittal through grooves or slots (not shown) in the base portions of the blades 60 for cooling the interior of the blade airfoil portions 75.

A second example of a stress concentrating feature may be a blade retention wire slot. The upstream or downstream face of the blade 60 and the disk 55 may be provided with an annular retention slot that extends circumferentially there around, passing through the radially inner portion of each dovetail 70 and dovetail slot 65. A blade retention wire may be inserted into a retention wire slot which in turn provides axial retention for the blades. In either of these examples and in similar situations, the stress concentrations potentially may be life-limiting locations of the turbine disk 55 and/or turbine blade 60.

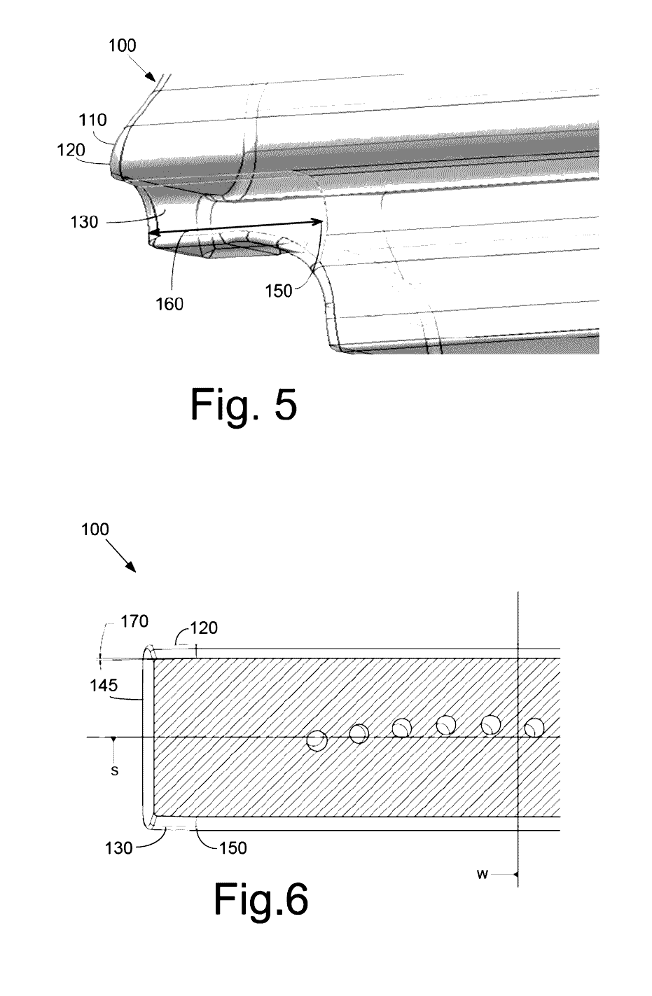

FIGS. 5 and 6 show an example of a turbine blade 100 as may be described herein. The blade 100 may include an airfoil 105 and a dovetail 110 similar to that described above. The dovetail 110 may include one or more pressure faces or tangs 120 extending on the dovetail pressure side and the dovetail suction side. Although one tang 120 is shown herein, any number of tangs 120 may be used. Depending on the turbine class and blade and disk stage, one or more backcuts 130 may be made on either or both of the suction side aft end and pressure side forward end of the blade dovetail tangs 120. Alternatively, the backcuts 130 also may be made in a number of slot tangs 140 in the dovetail slot 65 (see FIG. 2). The backcuts 130 may be formed by removing a predetermined amount of material from the tangs 120. The material may be removed using any suitable process such as a grinding or milling process or the like. Moreover, these processes may be the same as or similar to the corresponding processes used for forming the blade dovetail 110 (and/or disk dovetail slot 65).

The amount of material to be removed and thus the size of the backcut 130 may be determined by first finding a starting line 150 for the dovetail backcut 130 relative to a datum line M, i.e., the starting line 150 defining a length 160 therefrom of the dovetail backcut 130 along the dovetail axis. A cut angle 170 also may be determined for the backcut 130. The starting line 150 and the cut angle 170 may be optimized according to blade and disk geometry so as to maximize a balance between stress reduction on the turbine disk 55, stress reduction of the turbine blade 100, a useful life of the turbine blade 100, and maintaining or improving the aeromechanical behavior of the turbine blade 100. As such, if a dovetail backcut 130 is too large, the backcut 130 may have a negative effect on the life span of the turbine blade 100. If the dovetail backcut 130 is too small, although the life of the turbine blade 100 may be maximized, stress concentrations in the interface between the turbine blade and the disk may not be minimized such that the disk may not benefit from the maximized life span.

The backcut 130 may be planar or non-planar. In this context, the cut angle 170 may be defined as a starting cut angle. For some turbine classes, the cut angle 170 may be pertinent from the starting line 150 until the backcut 130 is deep enough that the blade loading face of the blade dovetail 110 loses contact with the disk dovetail slot 65. Once contact is lost with the disk dovetail slot 65, a cut of any depth or shape outside the defined envelope would be acceptable. If the blade dovetail 110 and disk dovetail slot 65 includes one or more tangs 120, 140, the starting line 150 and/or the cut angle 170 for the backcuts 130 may be determined separately for each of the number of tangs 120, 140. Dovetail backcuts 130 may be formed in one or both of the pressure side and suction side of the turbine blade 100 (and/or the dovetail slot 65).

The starting line 150 and the cut angle 170 for the dovetail backcut 130 may be determined by executing finite element analyses on the geometry of the blade and the disk. Virtual thermal and structural loads based on engine data may be applied to finite element grids of the blade 100 and the disk 55 to simulate engine operating conditions. The no-backcut geometry and a series of varying backcut geometries may be analyzed using the finite element model. A transfer function between the backcut geometry and blade and disk stresses may be inferred from the finite element analyses. The predicted stresses then may be correlated to field data using proprietary materials data in order to predict blade and disk lives and blade aeromechanical behavior for each backcut geometry. An optimum backcut geometry and an acceptable backcut geometry range may be determined through consideration of both the blade and disk life and the blade aeromechanical behavior.

The optimized starting line 150 and the cut angle 170 for each dovetail backcut 130 thus may be determined by using finite element analyses in order to maximize a balance between stress reduction on the turbine disk, stress reduction on the turbine blades, a useful life of the turbine blades, and maintaining or improving the aeromechanical behavior of the gas turbine blade. Although specific dimensions will be described, the turbine blade 100 described herein is not necessarily meant to be limited to such specific dimensions. The maximum dovetail backcut may be measured by the nominal distance to the starting line 150 shown from the datum line W. Through the finite element analyses, it has been determined that a larger dovetail backcut would result in sacrifices to the acceptable life of the gas turbine blade. In describing the optimal dimensions, separate values may be determined for the number of tangs 120, 140 of the blade dovetail 110 and/or the disk dovetail slots 65.

In this example, the datum line M also may vary according to blade or disk geometry. The datum line W may be positioned a fixed distance from a forward face 145 of the blade or disk dovetail along a center line S of the dovetail axis. In this example, the datum line M may be about 2.646 inches (about 67.208 millimeters) from the starting line 150 of the backcut 130. The datum line M, however, may range from about one inch to about 3.5 inches (about 25 to about 89 millimeters) or more from the starting line 150 or the front face 145. Other lengths may be used herein. The datum line W provides an identifiable reference point for each stage blade and disk of each turbine class for locating the optimized dovetail backcut starting line. In this example, the backcut 130 may be optimized for a second stage of a 9E.04 gas turbine engine offered by General Electric Company of Schenectady, N.Y.

The length 160 of the backcut 130 may be about 0.22 inches (about 5.588 millimeters), i.e., from the starting line 150 to the forward face 145. The length 160, however, may range from about 0.15 to about 0.3 inches (about 3.81 to about 7.62 millimeters). Given this range, the datum line W thus may be positioned about 2.866 inches (about 72.796 millimeters) from the forward face 145 of the dovetail 110 and may range from about 2.716 inches to about 2.566 inches (about 68.986 to about 65.176 millimeters) from the starting line 150 given the range of the backcut length described above. (This assumes, however, that the position of the datum line W remains fixed. Differing datum lines W also may be used herein.) Other distance may be used herein. The cut angle 170 also may be determined for the dovetail backcut 130. In this example, the cut angle 170 may be about 1.3 degrees. The cut angle 170, however, may range from about 0.7 degrees to about 2.0 degrees. Other cut angles 170 may be used herein. Other suitable sizes, shapes, and configurations may be used herein.

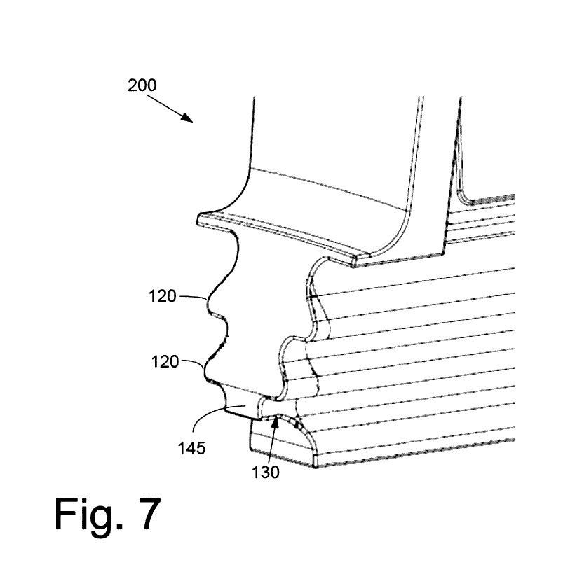

FIG. 7 shows a further embodiment of a turbine blade 200 as may be described herein. In this example, the turbine blade 200 may have a dovetail 110 with two tangs 120. The length 160 of the backcut 130 on each tang 120 thus may vary. The starting line 150 of the backcut 130 may be at about the same distance from the datum line M as is described above but with a variable backcut length 160. The cut angle 170 may be about 1.2 degrees. Other dimensions and other angles may be used herein.

It is anticipated that the dovetail backcuts may be formed into a unit during a normal hot gas path inspection process. With this arrangement, the blade load path should be diverted around the high stress region in the disk and/or blade stress concentrating features. The relief cut parameters including an optimized starting line relative to a datum line and an optimized cut angle define a dovetail backcut that maximizes a balance between stress reduction in the gas turbine disk, stress reduction in the gas turbine blades, a useful life of the gas turbine blades, and maintaining or improving the aeromechanical behavior of the gas turbine blade. The reduced stress concentrations serve to reduce distress in the gas turbine disk, thereby realizing a significant overall disk fatigue life benefit.

It should be apparent that the foregoing relates only to certain embodiments of the present application and the resultant patent. Numerous changes and modifications may be made herein by one of ordinary skill in the art without departing from the general spirit and scope of the invention as defined by the following claims and the equivalents thereof.

I claim:

1. A method for reducing stress on at least one of a turbine disk and a turbine blade, wherein a plurality of turbine blades are attachable to the disk, and wherein each of the turbine blades includes a blade dovetail engageable in a correspondingly-shaped dovetail slot in the disk, the blade dovetail having a pressure side and a suction side, the method comprising:
(a) determining a starting line for a dovetail backcut relative to a datum line, the starting line defining a length of the dovetail backcut along a dovetail axis;
(b) determining a cut angle for the dovetail backcut; and
(c) removing material from at least one of the blade dovetail or the disk dovetail slot according to the starting line and the cut angle to form the dovetail backcut, wherein the starting line and the cut angle are optimized according to blade and disk geometry to maximize a balance between stress reduction on the disk, stress reduction on the blade, a useful life of the turbine blades, and maintaining or improving the aeromechanical behavior of the turbine blade, wherein the datum line is positioned about 2.866 inches (about 72.796 millimeters) from a forward face of the blade dovetail along a centerline of the dovetail axis, and wherein step (a) is practiced such that for the pressure side of the dovetail, the starting line of the dovetail backcut is at least about 2.566 inches (about 65.176 millimeters) in a forward direction from the datum line.

2. A method according to claim 1, wherein for the suction side of the dovetail, the starting line of the dovetail backcut is at least about 2.566 inches (about 65.176 millimeters) in an aft direction from the datum line.

3. A method according to claim 1, wherein for the suction side or the pressure side of the dovetail, the starting line of the dovetail backcut is at least about 2.646 inches (about 67.208 millimeters) from the datum line.

4. A method according to claim 2, wherein step (b) is practiced such that the cut angle is a maximum of two degrees for each of the pressure side backcut and the suction side backcut.

5. A method according to claim 2, wherein step (b) is practiced such that the cut angle is a maximum of 1.3 degrees for each of the pressure side backcut and the suction side backcut.

6. A method according to claim 5, wherein optimizing of the starting line and the cut angle is practiced by executing finite element analyses on the blade and disk geometry.

7. A method according to claim 1, wherein step (b) is practiced by determining multiple cut angles to define the dovetail backcut with a non-planar surface.

8. A method according to claim 1, wherein step (c) is practiced by removing material from the blade dovetail.

9. A method according to claim 1, wherein step (c) is practiced by removing material from the disk dovetail slot.

10. A method according to claim 1, wherein step (c) is practiced by removing material from the blade dovetail and from the disk dovetail slot.

11. A method according to claim 10, wherein step (c) is further practiced such that a resulting angle based on the material removed from the blade dovetail and the disk dovetail slot does not exceed the cut angle.

12. A turbine blade comprising an airfoil and a blade dovetail, the blade dovetail being shaped corresponding to a dovetail slot in a turbine disk, the blade dovetail having a pressure side and a suction side, wherein the blade dovetail includes a dovetail backcut sized and positioned according to blade geometry to maximize a balance between stress reduction on the disk, stress reduction on the blade, a useful life of the turbine blade, and maintaining or improving the aeromechanical behavior of the turbine blade, wherein a starting line of the dovetail backcut, which defines a length of the dovetail backcut along a dovetail axis, is determined relative to a datum line positioned about 2.866 inches (about 72.796 millimeters) from a forward face of the blade dovetail along a centerline of the dovetail axis, and wherein for the pressure side of the dovetail, the starting line of the dovetail backcut is at least about 2.566 inches (about 65.176 millimeters) in a forward direction from the datum line.

13. A turbine blade according to claim 12, wherein for the suction side of the dovetail, the starting line of the dovetail backcut is at least about 2.566 inches (about 65.176 millimeters) in an aft direction from the datum line.

14. A turbine blade according to claim 12, wherein for the suction side or the pressure side of the dovetail, the starting line of the dovetail backcut is at least about 2.646 inches (about 67.208 millimeters) from the datum line.

15. A turbine blade according to claim 13, wherein a cut angle for each of the pressure side backcut and the suction side backcut is a maximum of two degrees.

16. A turbine blade according to claim 13, wherein a cut angle for each of the pressure side backcut and the suction side backcut is a maximum of 1.3 degrees.

17. A turbine blade according to claim 12, wherein the dovetail backcut has a non-planar surface.

18. A turbine rotor including a plurality of turbine blades coupled with a rotor disk, each blade comprising an airfoil and a blade dovetail, and the rotor disk comprising a plurality of dovetail slots shaped corresponding to the blade dovetail, the blade dovetail having a pressure side and a suction side, wherein at least one of the blade dovetail and the dovetail slot includes a dovetail backcut sized and positioned according to blade and disk geometry to maximize a balance between stress reduction on the rotor disk, stress reduction on the blade, a useful life of the turbine blade, and maintaining or improving the aeromechanical behavior of the turbine blade, wherein a starting line of the dovetail backcut, which defines a length of the dovetail backcut along a dovetail axis, is determined relative to a datum line positioned 2.866 inches (72.796 millimeters) from a forward face of the blade dovetail along a centerline of the dovetail axis, and wherein for the pressure side of the dovetail the starting line of the dovetail backcut is at least 2.566 inches (about 65.176 millimeters) in a forward direction from the datum line.

19. A turbine rotor according to claim 18, wherein for the suction side of the dovetail, the starting line of the dovetail backcut is at least 0.22 inches (5.59 millimeters) in an aft direction from the datum line.

20. A turbine rotor according to claim 18, wherein for the suction side or the pressure side of the dovetail, the starting line of the dovetail backcut is at least about 2.646 inches (about 67.208 millimeters) from the datum line.
